(19) United States
(12) Patent Application Publication
(10) Pub. No.: US 2026/0357883 A1
(43) Pub. Date: Nov. 12, 2026

(54) TILT COMPENSATION FOR A SHAFT IN A DRIVE UNIT

(71) Applicant: Rivian IP Holdings, LLC, Irvine, CA (US)

(72) Inventors: Jaymes M. WAINRIGHT, Livonia, MI (US); Eric SHARKNESS, Canton, MI (US); Gary Allen PINKLEY, Northville, MI (US)

(21) Appl. No.: 19/204,266

(22) Filed: May 9, 2025

(51) Int. Cl. F16H 57/021; F16H 57/023; F16H 57/031; F16H 57/02

(52) U.S. Cl. CPC F16H 57/021; F16H 57/023; F16H 57/031; F16H 2057/02034; F16H 2057/02043; F16H 2057/0216

(57) ABSTRACT

A vehicle includes a drive unit. The drive unit includes a shaft having a gear and a motor configured to drive rotation of the shaft about an axis of ration. The drive unit includes a first bearing configured to support the shaft and a second bearing that is removably couplable to the shaft. When the second bearing is coupled to the shaft, the gear is positioned between the first bearing and the second bear along the axis of rotation. The drive unit includes a motor housing and a pilot feature coupled to the motor housing. The pilot feature supports the shaft when the second bearing is decoupled from the shaft and does not support the shaft when the second bearing is coupled to the shaft.

### INTRODUCTION

The present disclosure relates to drive units for vehicles and, more particularly, to a drive unit having a straddle two-bearing arrangement and a motor housing with a pilot feature for tilt compensation of a shaft of the drive unit.

### SUMMARY

In one aspect, a vehicle includes a drive unit. The drive unit includes a shaft having a gear. The drive unit includes a motor configured to drive rotation of the shaft about an axis of rotation. The drive unit includes a first bearing configured to support the shaft. The drive unit includes a second bearing removably couplable to the shaft to support shaft. When the second bearing is coupled to the shaft, the gear of the shaft is positioned between the first bearing and the second bearing along the axis of rotation. The drive unit includes a motor housing and a pilot feature coupled to the motor housing. The pilot feature supports the shaft when the second bearing is decoupled from the shaft and does not support the shaft when the second bearing is coupled to the shaft.

In another aspect, a drive unit includes a shaft having a gear. The drive unit includes a motor configured to drive rotation of the shaft about an axis of rotation. The drive unit includes a first bearing configured to support the shaft. The drive unit includes a second bearing removably couplable to the shaft to support shaft. When the second bearing is coupled to the shaft, the gear of the shaft is positioned between the first bearing and the second bearing along the axis of rotation. The drive unit includes a motor housing and a pilot feature coupled to the motor housing. The pilot feature supports the shaft when the second bearing is decoupled from the shaft and does not support the shaft when the second bearing is coupled to the shaft.

In yet another aspect, a method for assembling a drive unit includes engaging a shaft of the drive unit with a pilot feature that is coupled to a motor housing of the drive unit, with the pilot feature supporting the shaft while the shaft is supported by a first bearing of a straddle two-bearing arrangement. The method further includes coupling a gearbox cover to the motor housing to cause a second bearing of the straddle two-bearing arrangement to support the shaft, which causes the pilot feature to disengage the shaft

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2A is a schematic block diagram of components of a vehicle in accordance with certain embodiments.

FIG. 2B is a schematic block diagram of alternative components of a vehicle in accordance with certain embodiments.

FIG. 3A illustrates a drive unit for a vehicle in accordance with certain embodiments.

FIG. 3B illustrates the drive unit of FIG. 3A with the gearbox cover removed in accordance with certain embodiments.

FIG. 4A illustrates a drive unit having a pilot feature in accordance with certain embodiments.

FIG. 4B illustrates the drive unit of FIG. 4B with the gearbox cover removed in accordance with certain embodiments.

FIG. 5A illustrates a position of a shaft of the drive unit of FIG. 4A and the pilot feature of the drive unit in accordance with certain embodiments.

FIG. 5B illustrates a position of a shaft of the drive unit of FIG. 4B and the pilot feature of the drive unit in accordance with certain embodiments.

FIG. 6 illustrates a side profile of a pilot feature in accordance with certain embodiments.

FIG. 7 is a process flow diagram of a method for assembling a drive unit in accordance with certain embodiments.

### DETAILED DESCRIPTION

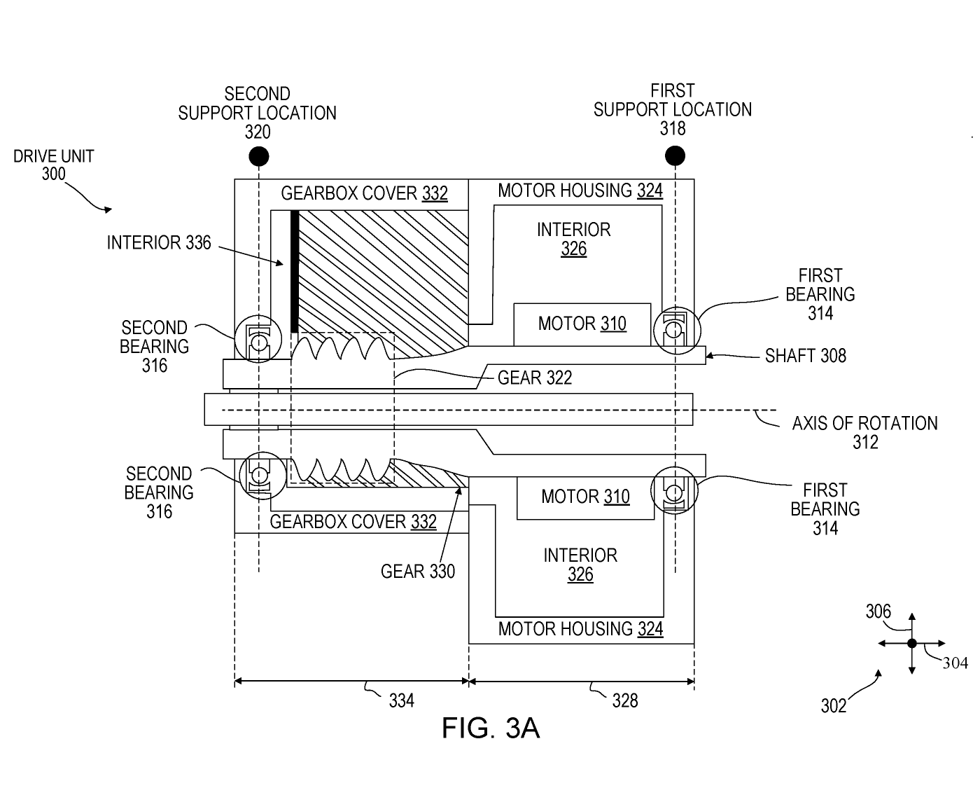

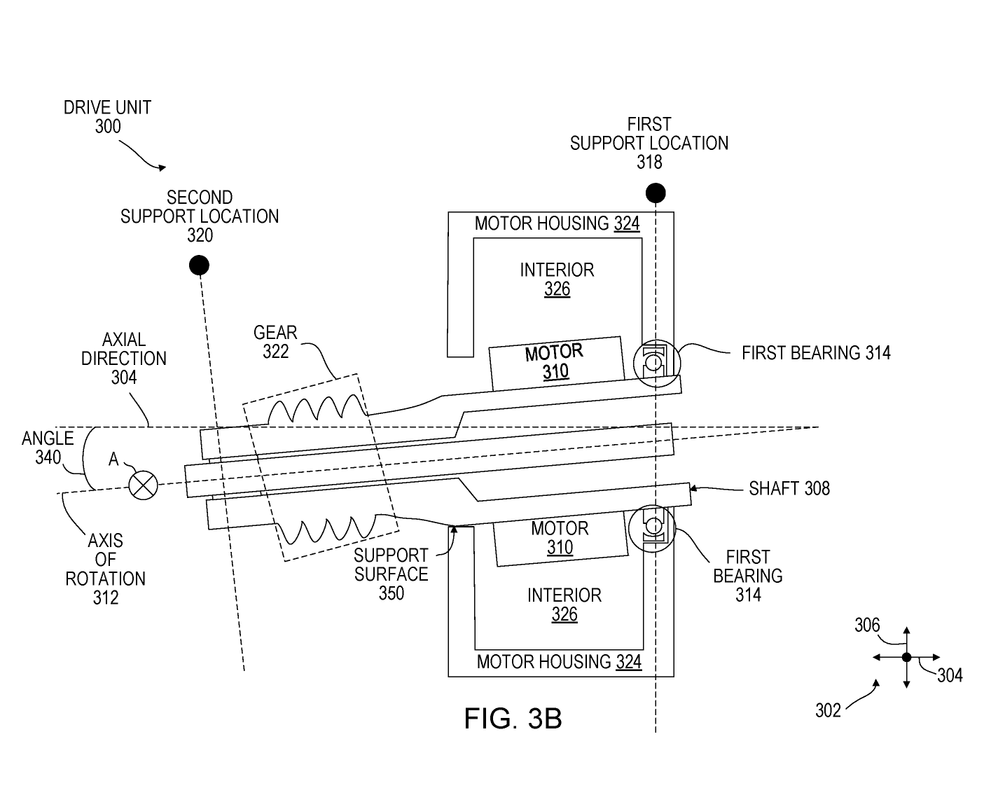

Drive units for vehicles may include a shaft that is supported by a straddle two-bearing arrangement. Two-bearing arrangements are generally preferred, because such bearing arrangements include fewer bearings compared to other bearing arrangements (e.g., four-bearing arrangements) and thus experience less friction losses (e.g., from the shaft rotating on the bearings). However, as will be discussed in more detail with reference to FIGS. 3A and 3B, the shaft of such drive units may, at various stages of the assembly process, be supported by a single bearing, which may cause the shaft to tilt. Such tilting makes it difficult to test functionality of various components of such drive units, such as testing a back electromagnetic force (EMF) voltage of an electric motor of such drive units. Conventional approaches for compensating for the tilt the shaft experiences when supported by a single bearing of the straddle two-bearing arrangement require additional tooling to compensate for the tilt to allow for test of various components (e.g., the motor) to be performed despite the shaft being supported by only one bearing of the straddle two-bearing arrangement.

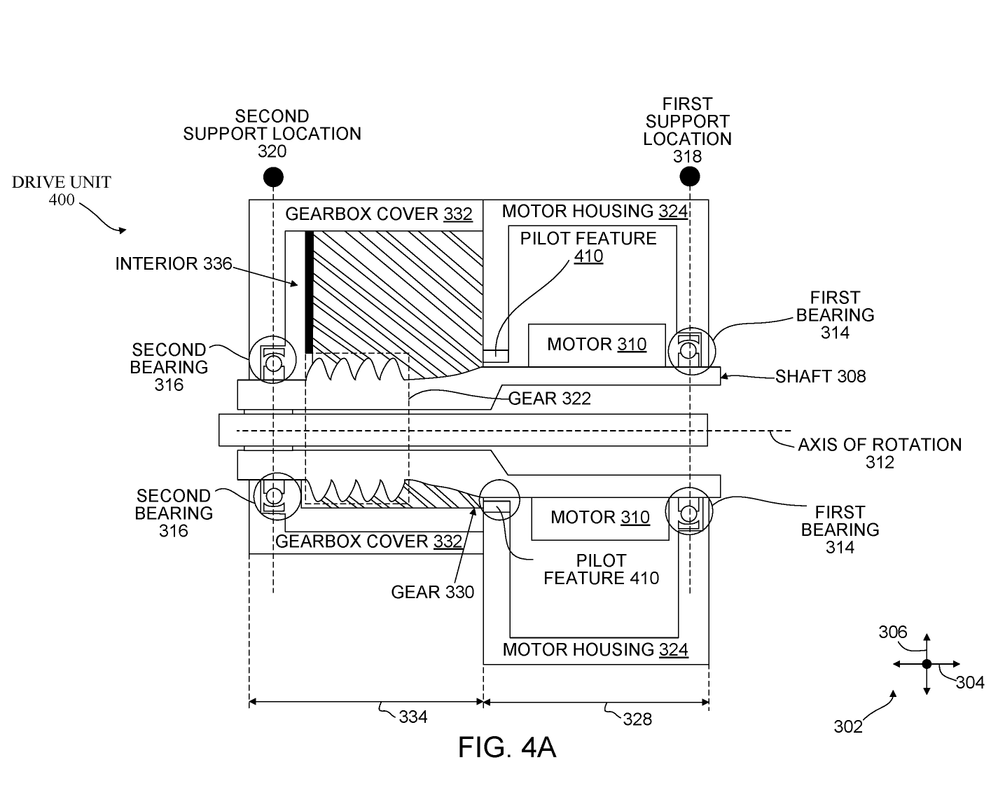

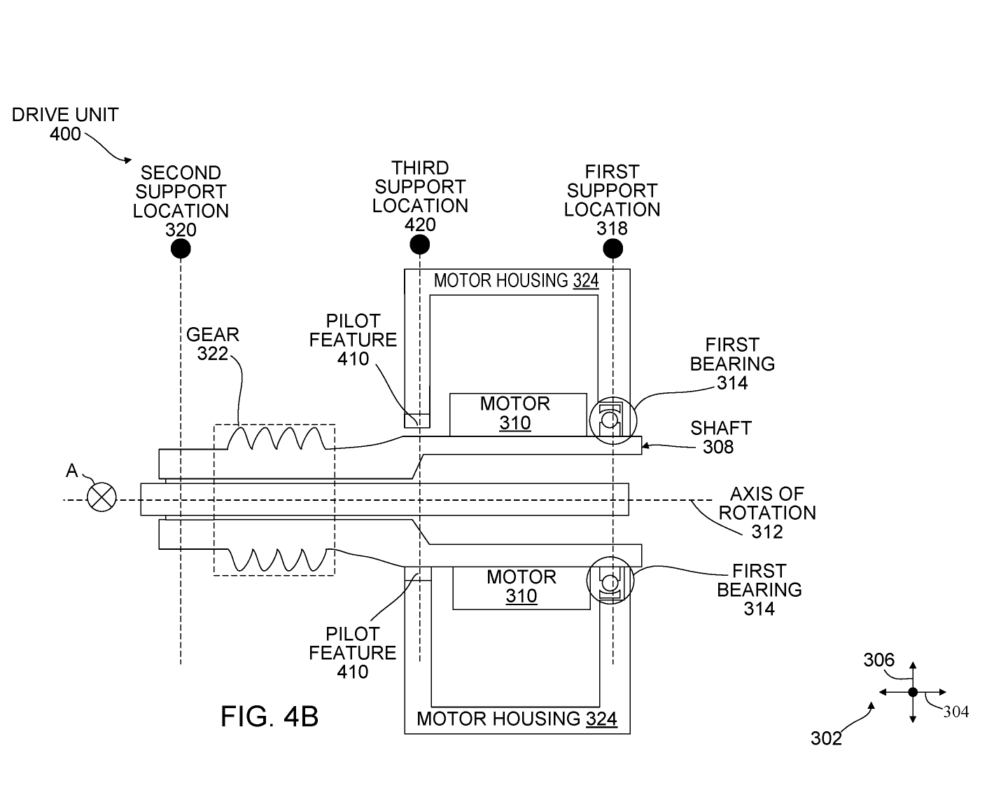

Example aspects of the present disclosure are directed to a drive unit having a pilot feature to compensate for tilt in the shaft when the shaft is supported by only one bearing of the straddle two-bearing arrangement. For instance, as will be discussed in more detail with reference to FIGS. 4A and 4B, the pilot feature may be part of a motor housing of the drive unit, and a radial fit defined between the pilot feature and the shaft may be sized such that the pilot feature is active when the shaft is supported by only one bearing of the straddle two-bearing arrangement and is inactive when the shaft is supported by both bearings of the straddle two-bearing arrangement. For instance, when the pilot feature is active, the pilot feature may support the shaft and compensate for the tilt that the shaft typically experiences when supported by only one bearing of the straddle two-bearing arrangement. Furthermore, when the pilot is inactive, the pilot feature may avoid contact with the shaft and thus does not create friction losses that would result from such contact between the pilot feature and the spinning shaft.

Example aspects of the present disclosure provide numerous technical effects and benefits. For example, by having a motor housing with the pilot feature, drive units according to the present disclosure can compensate for tilt of the shaft without requiring additional tooling. Furthermore, since the pilot feature is inactive when the shaft is supported by both bearings of the straddle two-bearing arrangement, the pilot feature does not create additional friction losses for such drive units.

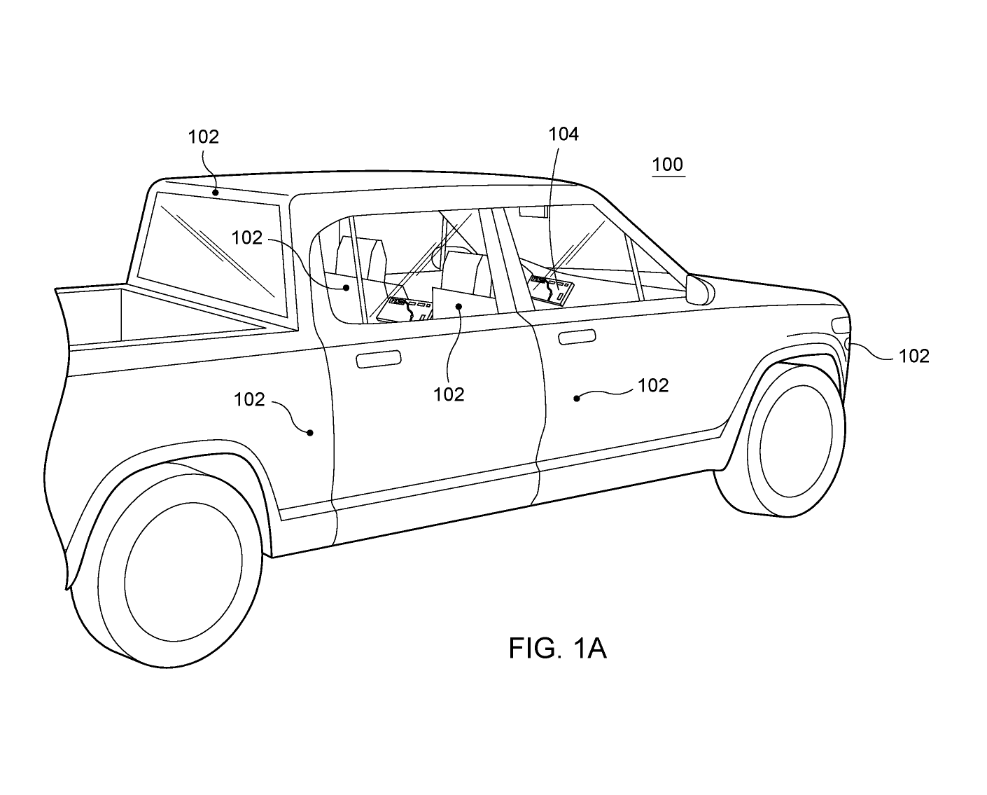

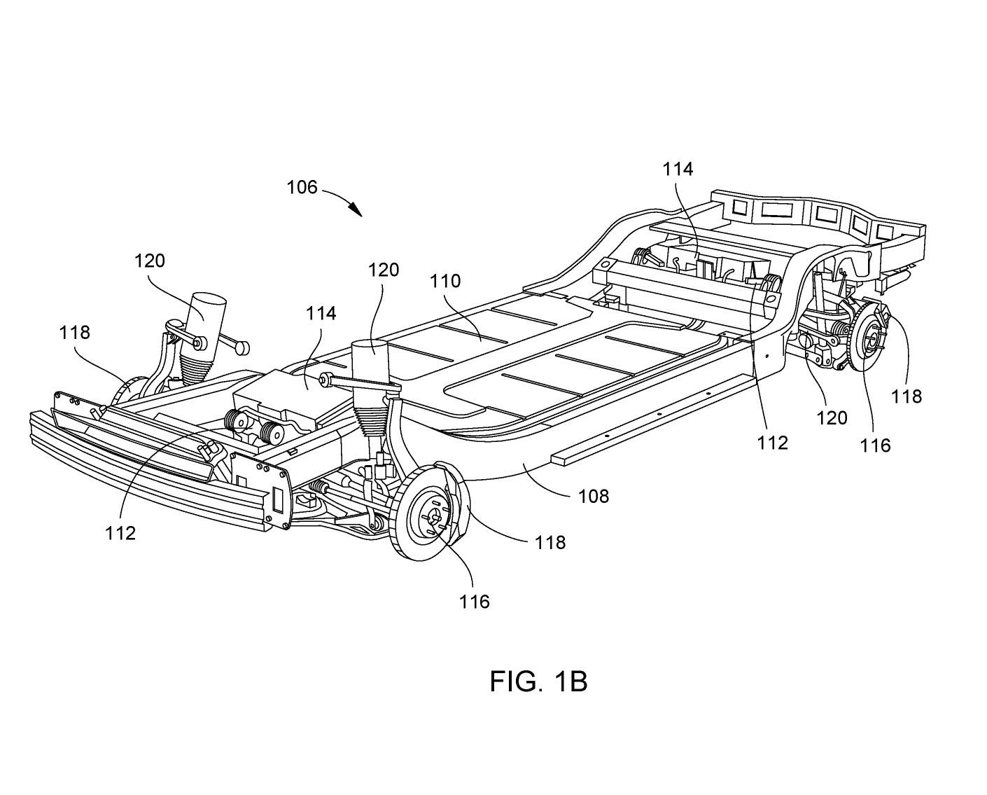

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (e.g., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100. In still other embodiments, there are three drive units 112 with one drive unit 112 driving the front wheels and two drive units 112 driving the rear wheels or two drive units 112 driving the front wheels and one drive unit 112 driving the rear wheels. Additionally, in various embodiments, a single drive unit 112 may include multiple motors. For example, a single drive unit 112 may include two motors, each of which drives a different rear wheel, or each of which drives a different front wheel.

Power from the battery 110 may be supplied to the drive units 112 by one or more sets of power module 114, such as power module for each drive unit 112 or pair of drive units 112. The power module 114 may include inverters configured to convert direct current (DC) from the battery 110 into alternating current (AC) supplied to the motors of the drive units 112. The power module 114 further facilitate operation of the motors of the drive units as generators to provide regenerative braking. The power module 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, a hybrid-electric vehicle may also benefit from the approach described herein. Likewise, non-vehicular applications that use an inverter or other relevant power component may also benefit from the approach described herein.

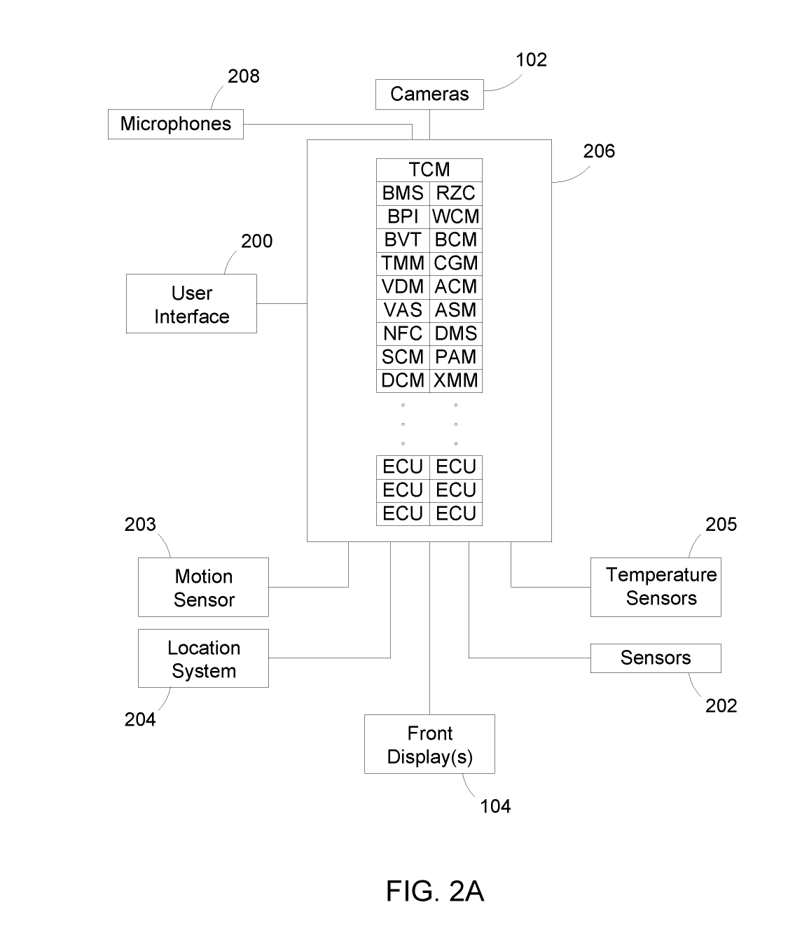

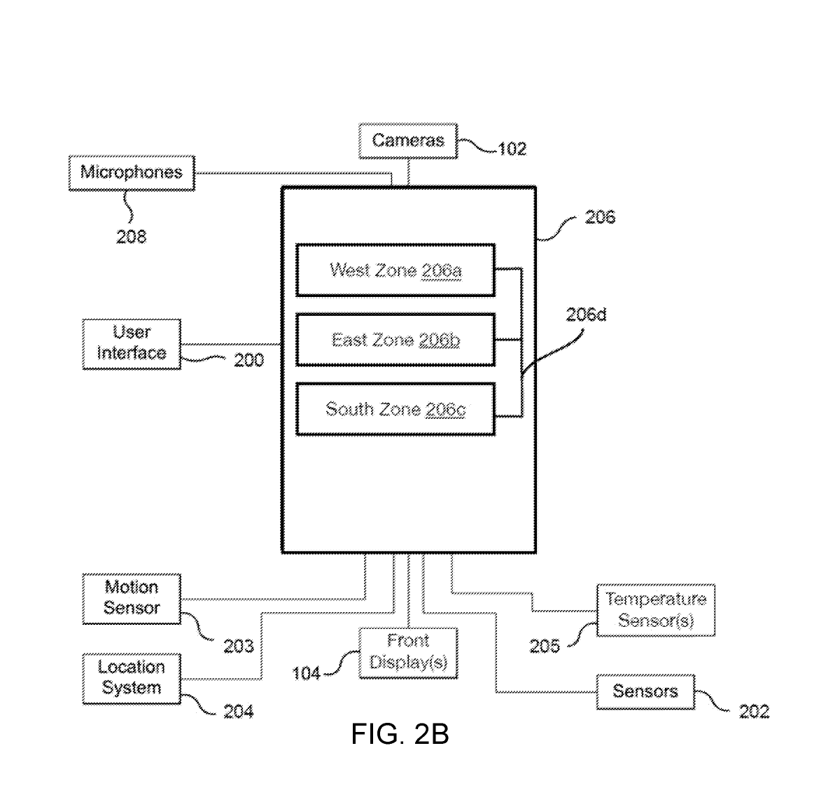

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of each of the power modules 114, temperature of each drive unit 112 and/or each motor of each drive unit 112, or the temperature of any other component of the vehicle 100.

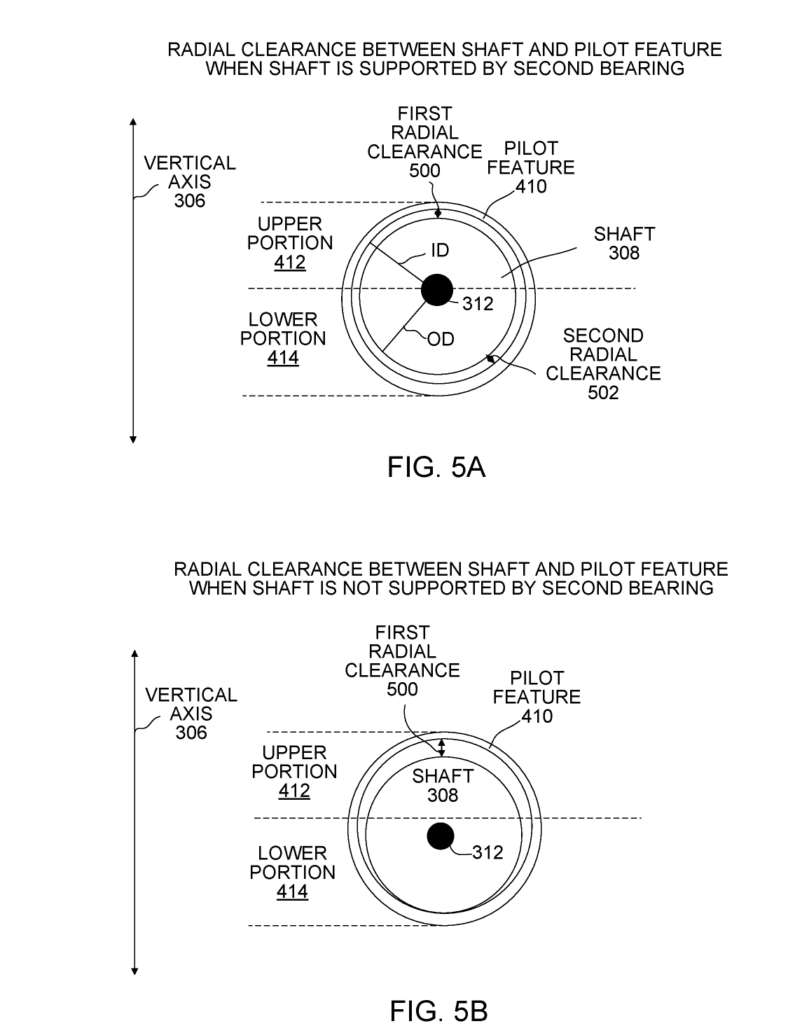

A control system 206 executes instructions to perform at least some of the actions or functions of the vehicle 100, including the functions described in relation to FIGS. 4 and 5. For example, as shown in FIG. 2A, the control system 206 may include one or more electronic control units (ECUs) configured to perform at least some of the actions or functions of the vehicle 100. In certain embodiments, each of the ECUs is dedicated to a specific set of functions. Each ECU may be a computer system.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle’s communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

FIGS. 3A and 3B depict a drive unit 300 for use in a vehicle according to some embodiments of the present disclosure. The drive unit 300 may be implemented as one or more of the drive units 112 of the vehicle 100 discussed above with reference to FIGS. 1A and 1B. Furthermore, the drive unit 300 may define a coordinate system 302 that includes an axial direction 304 and a vertical direction 306 that is generally perpendicular to the axial direction 304.

The drive unit 300 may include a shaft 308 and a motor 310 configured to drive rotation of the shaft 308 about an axis of rotation 312 (e.g., generally parallel to the axial direction 304). In some embodiments, the motor 310 may be an electric motor that includes a stator and a rotor mounted to the shaft 308. The rotor may have a magnetic field that interacts with a rotating magnetic field of the stator to cause the rotor to spin as well as the shaft 308 to which the rotor is mounted.

The drive unit 300 may include a first bearing 314 and a second bearing 316 to support the shaft 308. For instance, the first bearing 314 may be configured to support the shaft 308 from a first support location 318. The second bearing 316 may be configured to support the shaft 308 from a second support location 320 that is spaced apart from the first support location 318 along the axis of rotation 312. For instance, as illustrated in FIG. 3A, the shaft 308 may include a gear 322 that is positioned between the first support location 318 and the second support location 320 along the axis of rotation 312. In this manner, the first bearing 314 and the second bearing 316 may collectively be referred to as a straddle two-bearing arrangement.

The drive unit 300 may include a motor housing 324 that surrounds the motor 310 and a first portion 328 of the shaft 308. In this manner, the motor 310 and the first portion 328 of the shaft 308 may be positioned within an interior 326 of the motor housing 324. In some embodiments, the first portion 328 of the shaft 308 that is positioned within the interior 326 of the motor housing 324 may include the first support location 318 at which the first bearing 314 supports the shaft 308. In such embodiments, the first bearing 314 may also be positioned within the interior 326 of the motor housing 324.

The drive unit 300 may include one or more gears 330 (only one shown) that are configured to mesh with the gear 322 of the shaft 308. The gear(s) 330 may also be rotatably coupled to a load. In this manner, power (e.g., torque) generated by the motor 310 driving rotation of the shaft 308 about the axis of rotation 312 may be transmitted to the driveshaft via the gear(s) 330. Furthermore, the gear(s) 330 may be configured to adjust (e.g., decrease) the power output by the shaft 308.

The drive unit 300 may include a gearbox cover 332 that is removably couplable to the motor housing 324. For instance, the gearbox cover 332 may be coupled to (e.g., via one or more fasteners) the motor housing 324 such that the gearbox cover 332 surrounds the gear(s) 330 and a second portion 334 of the shaft 308. In this manner, the gear(s) 330 and the second portion 334 of the shaft 308 may be disposed (e.g., positioned within) the interior 336 of the gearbox cover 332. In some embodiments, the second portion 334 of the shaft 308 may include the second support location 320 at which the second bearing 316 supports the shaft 308. In such embodiments, the second bearing 316 may also be positioned within the interior 336 of the gearbox cover 332.

In some embodiments, the gearbox cover 332 may include the second bearing 316. For instance, the gearbox cover 332 may define a cavity in which the second bearing is positioned. Thus, in such embodiments, the second bearing 316 may be installed (e.g., to support the shaft 308 from the second support location 320) when the gearbox cover 332 is coupled to the motor housing 324. Furthermore, the second bearing 316 may be uninstalled by decoupling the gearbox cover 332 from the motor housing 324.

As shown in FIG. 3B, when the gearbox cover 332 is removed, the shaft 308 is unsupported at the second support location 320. Consequently, the shaft 308 rotates about an axis A (e.g., perpendicular to the axis of rotation 312) until the shaft 308 contacts a support surface 350 of the motor housing 324. Furthermore, the rotation of the shaft 308 (e.g., about the axis A) that results from the shaft 308 being unsupported at the second support location 320 causes the axis of rotation 312 of the shaft 308 and the axial direction 304 of the drive unit 300 to be non-parallel. Stated another way, an angle 340 forms between the axial direction 304 and the axis of rotation 312. In some embodiments, the value of the angle 340 may be limited by a radial gap between the rotor and the stator as magnetic forces will hold the rotor towards the stator with a magnetic force such that it may be difficult to reposition the shaft 308 if the shaft is not properly supported.

During assembly of the drive unit 300, tests may be performed on different components thereof at various stages of the assembly process. For example, the back electromagnetic force (EMF) voltage of the motor 310 may be tested before the gearbox cover 332 is installed. Testing the back EMF voltage of the motor 310 generally involves attaching a machine to the shaft 308, specifically the end that is closest to the second support location 320. However, since the shaft 308 is rotated as shown in FIG. 3B due to being unsupported at the second support location 320, attaching the machine to the shaft may be difficult, for example, if the shaft must be repositioned to engage the machine. In some instances, additional tooling may be required to reposition the shaft 308 so that the machine can be attached to the shaft 308 to perform the operations associated with testing the back EMF voltage of the motor 310.

Example aspects of the present disclosure are directed to a drive unit that overcomes the aforementioned problems with the drive unit 300 discussed above with reference to FIGS. 3A and 3B. For instance, as will be discussed in more detail with reference to FIGS. 4A and 4B, the motor housing of drive units according to the present disclosure may include a pilot feature (e.g., non-bearing surface) that is active (e.g., as described below) when the shaft is not supported at the second support location. For instance, when the gearbox cover is removed (or yet to be installed) and thus the shaft is supported by a single bearing, the pilot feature may support the shaft to minimize (or at least reduce) rotation of the shaft (e.g., along an axis perpendicular to the axis of rotation for the shaft) due to the absence of the support from another bearing. This may improve (e.g., simplify) testing of various components of drive units that are tested under such conditions (e.g., when the shaft is not supported by both bearings of the straddled two-bearing arrangement) by reducing or eliminating the need for additional tooling to support the shaft during such testing. Furthermore, the pilot feature may be inactive when the shaft is supported by both bearings of the straddled two-bearing arrangement, preventing the pilot feature from contacting the shaft and thus avoiding friction loss that is associated with such contact between the pilot feature and the shaft.

FIGS. 4A and 4B depict a drive unit 400 according to some embodiments of the present disclosure. The drive unit 400 is substantially similar to the drive unit 300 discussed above with reference to FIGS. 3A and 3B. For instance, the drive unit 400 includes the shaft 308, the motor 310, the first bearing 314, the second bearing 316, the motor housing 324, the gear(s) 330, and the gearbox cover 332. However, in contrast to the motor housing 324 of the drive unit 300 of FIGS. 3A and 3B, the drive unit 400 depicted in FIGS. 4A and 4B includes a pilot feature 410 that is active (e.g., supports the shaft 308) when the shaft 308 is unsupported at the second support location 320 (e.g., due to the gearbox cover 332 being removed or not yet being installed) and inactive (e.g., does not support the shaft 308) when the shaft 308 is supported at the second support location 320.

In some embodiments, the pilot feature 410 may be separate from the motor housing 324. In this manner, the pilot feature 410 may be inserted between the motor housing 324 and the shaft 308. In other embodiments, the pilot feature 410 may be integrally formed with the motor housing 324. The pilot feature 410 may be formed from any suitable material. In some embodiments, the pilot feature 410 and the motor housing may 324 may be formed from the same material (e.g., aluminum). In other embodiments, the pilot feature 410 may be formed from a different material than the material used to form the motor housing 324. For instance, the pilot feature 410 may be formed from material having a lower hardness factor compared to material (e.g., aluminum) used to form the motor housing 324.

The pilot feature 410 may generally have any suitable shape. For instance, in some embodiments, the shape of the pilot feature 410 may be similar to the shape of the portion of the shaft 308 that the pilot feature 410 may support when the shaft 308 is unsupported at the second support location 320. For example, the pilot feature 410 and the shaft 308 may both be circular in shape.

The pilot feature 410 may extend around (e.g., along a circumferential direction of) the shaft 308 at a third support location 420 thereon that is positioned between the first support location 318 and the second support location 320 along the axis of rotation 312. Furthermore, the radial fit between the pilot feature 410 and shaft 308 may be sized to control deflection of the shaft 308 at the third support location 420, particularly when the gearbox cover 332 is removed (or yet to be installed) and the shaft 308 is unsupported at the second support location 320. As used herein, “radial fit” refers to a radial distance between an outer diameter of the shaft 308 (e.g., at the third support location 420) and an inner diameter of the pilot feature 410.

The radial fit between the pilot feature 410 and the shaft 308 may be a function of the outer dimeter of the shaft 308 at the third support location 420. For instance, in some embodiments, the outer dimeter of the shaft 308 at the third support location 420 may generally range from 30 millimeters (mm) to 120 mm, such as 50 mm to 80 mm, such as 60 mm to 70 mm, such as 65 mm. The radial fit between the pilot feature 410 and the shaft 308 may also be a function of the inner diameter of the pilot feature. In some embodiments, the inner diameter of the pilot feature 410 may range from 10 to 90 mm, such as 40 mm to 80 mm, such as 60 mm to 70 mm, such 65 mm. Alternatively, or additionally, the radial fit between the pilot feature 410 and the shaft 308 may range from 0.1 mm to 15 mm, such as 0.5 mm.

FIGS. 5A and 5B depict the position of the shaft 308 and the pilot feature 410 according to some embodiments of the present disclosure. For instance, FIG. 5A depicts the position of the shaft 308 relative to the pilot feature 410 when the shaft 308 is supported by both bearings (e.g., first bearing 314 and second bearing 316) of the straddle two-bearing arrangement as depicted in FIG. 4A. Furthermore, FIG. 5B depicts the position of the shaft 308 relative to the pilot feature 410 when the shaft 308 is only supported by one bearing (e.g., first bearing 314) of the straddle two-bearing arrangement as depicted in FIG. 4B.

When the shaft 308 is supported by both bearings of the straddle two-bearing arrangement as depicted in FIG. 4A, the radial fit between the outer diameter (e.g., labeled “OD”) of the shaft 308 and the inner diameter (e.g., labeled “ID”) of the pilot feature 410 may be uniform all the way around the circumference of the shaft 308 as shown in FIG. 5A. More specifically, a first radial fit 500 defined between the shaft 308 and an upper portion 412 of the pilot feature 410 is substantially the same as a second radial fit 502 defined between the shaft 308 and a lower portion 414 of the pilot feature 410.

In some embodiments, the thickness of the pilot feature 410 may be non-uniform. For example, the upper portion 412 of the pilot feature 410 may have a first thickness and the lower portion 414 of the pilot feature 410 may have a second thickness that is different (e.g., thicker, thinner) than the first thickness. Furthermore, in such embodiments, the first radial fit 500 and the second radial fit 502 may be substantially the same despite the non-uniform thickness of the pilot feature 410.

When the shaft 308 is supported by only one of the bearings (e.g., the first bearing 314, as depicted in FIG. 4B) of the straddle 2-bearing arrangement, the shaft 308 rotates about an axis (e.g., axis A in FIG. 4B) that is perpendicular to the axis of rotation 312. This rotation about the axis perpendicular to the axis of rotation 312 causes the shaft 308 to tilt downward along the vertical direction 306 and, as a result, changes the position of the shaft 308 relative to the pilot feature 410.

The change in position of the shaft 308 relative to the pilot feature 410 causes the radial fit between the shaft 308 and the pilot feature 410 to become non-uniform. For example, as shown FIG. 5B, the first radial fit 500 defined between the shaft 308 and the upper portion 412 of the pilot feature 410 widens compared to the first radial fit 500 depicted in FIG. 5A, whereas the second radial fit 502 defined between the shaft 308 and the lower portion 414 of the pilot feature 410 shortens compared to the second radial fit 502 depicted in FIG. 5A. For instance, as shown in FIG. 5B, a portion of the shaft 308 contacts (e.g., touches) a support surface for the pilot feature 410, specifically the support surface that is part of the lower portion 414 of the pilot feature 410. In this manner, the shaft 308 may be supported by the pilot feature 410, specifically the lower portion 414 thereof, while the shaft 308 is unsupported at the second support location (e.g., second support location 320 in FIG. 4B) along the shaft 308.

In various embodiments, the radial fit defined between the shaft 308 and the pilot feature 410 may compensate for the tilt in the shaft 308 that results from the shaft 308 being unsupported at the second support location along the shaft 308. More specifically, the radial fit defined between the shaft 308 and the pilot feature 410 may minimize or reduce the tilt of the shaft 308 when the shaft 308 is unsupported at the second support location. For instance, when the shaft 308 is unsupported at the second support location, the pilot feature 410 may compensate for the tilt of the shaft 308 such that the axis of rotation 312 for the shaft 308 remains substantially parallel to the axial direction 304. In this manner, the pilot feature 410 may allow testing (e.g., of back EMF voltage) of the motor 310 to be performed while the shaft 308 is unsupported at the second support location without requiring additional tooling that may be needed to perform such tests. More specifically, the pilot feature 410 may allow test equipment associated with performing the test on the motor 310 to engage an end of the shaft 308, e.g., lift the shaft 308 such that the shaft 308 is no longer supported by the pilot feature 410. Furthermore, while the shaft 308 is lifted off of the pilot feature 410, the test machine may perform the test on the motor 310 and, once the test is finished, may set the shaft back down on the pilot feature such that the shaft 308 is once again supported by the pilot feature 410.

In some embodiments, the pilot feature 410 may prevent components of the motor 310 from contacting one another during assembly of the drive unit 400. For instance, the motor 310 may be an electric motor including a rotor and a stator, and the pilot feature 410 may be configured to maintain a gap between the rotor and the stator to prevent the rotor from contacting (e.g., touching) the stator during assembly of the drive unit 400 or to prevent the rotor from being close enough to the stator to make repositioning the shaft 308 difficult, e.g., due to magnetic forces pulling on the rotor.

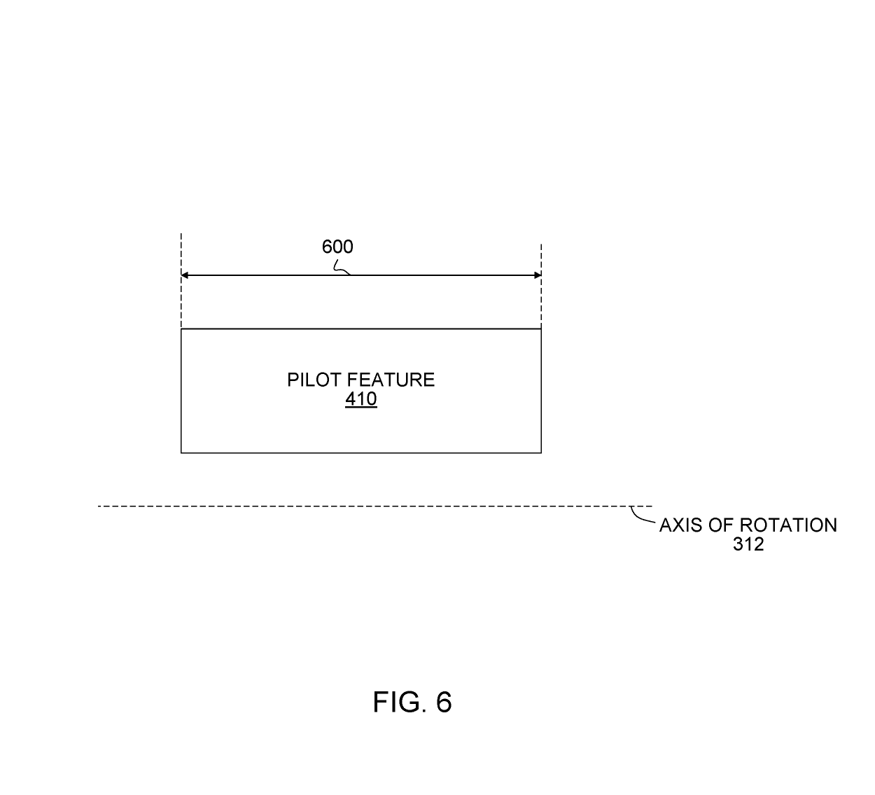

FIG. 6 depicts a side profile of the pilot feature 410 taken along the axis of rotation 312 according to some embodiments of the present disclosure. As shown, a length 600 of the pilot feature 410 may be measured along the axis of rotation 312. It should be understood that the length 600 of the pilot feature 410 determines how much of the shaft 308 the pilot feature surrounds (e.g., circumferentially). In some embodiments, the length 600 of the pilot feature 410 may range from 2 mm to 60 mm, such as from 10 mm to 20 mm, such as 15 mm.

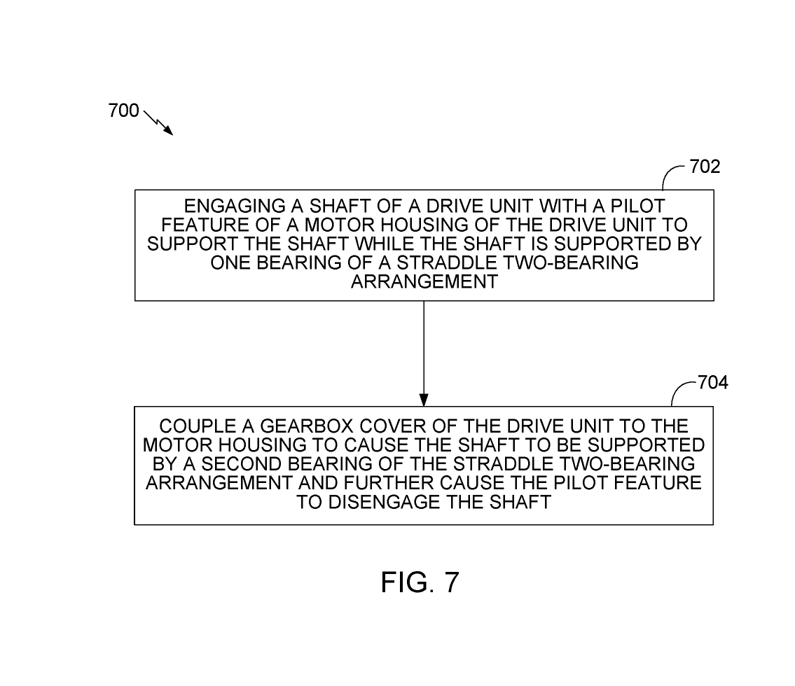

FIG. 7 depicts a method 700 for assembling a drive unit according to some embodiments of the present disclosure. The method 700 may be performed using the drive unit 400 discussed above with reference to FIGS. 4A and 4B.

At 702, the method 700 may include engaging the shaft with a pilot feature that is coupled to a motor housing of the drive unit to support the shaft while the shaft is supported by only one bearing of a straddle two-bearing arrangement. For instance, the pilot feature may engage the shaft by contacting a portion of the shaft to compensate for tilting of the shaft that occurs when the shaft is supported by only one bearing of the straddle two-bearing arrangement.

At 704, the method 700 may include coupling a gearbox cover to the motor housing to cause the shaft to be supported by a second bearing and further cause the pilot feature to disengage the shaft. More specifically, the pilot feature may disengage the shaft such that no portion of the pilot feature is in contact with (e.g., touching) the shaft. In this manner, friction losses associated with the shaft contacting the pilot feature while spinning may be avoided, especially when the shaft is deflecting under high torque loads of the motor.

In some embodiments, the method 700 may include performing a test on a component (e.g., the motor) of the drive unit before coupling the gearbox cover to the motor housing at 706. For instance, performing the test on the component of the drive unit may include engaging an end of the shaft with a test machine causing the pilot feature to disengage the shaft. More specifically, the test machine may lift the shaft such that the shaft is no longer supported (e.g., not contacting) by the pilot feature. Furthermore, with the pilot feature disengage, the test machine may perform the test on the component. Once the test of the component is finished, the test machine may disengage the shaft causing the pilot feature to reengage the shaft. More specifically, with the test machine no longer engaging the shaft, the shaft may again be supported by the pilot feature.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. A vehicle comprising:
a drive unit including:
a shaft having a gear;
a motor configured to drive rotation of the shaft about an axis of rotation;
a first bearing configured to support the shaft;
a second bearing removably couplable to the shaft to support the shaft, wherein the gear is positioned between the first bearing and the second bearing along the axis of rotation when the second bearing is coupled to the shaft;
a motor housing; and
a pilot feature coupled to the motor housing,
wherein when the second bearing is decoupled from the shaft, the shaft is supported by the pilot feature, and
wherein when the second bearing is coupled to the shaft, the shaft is not supported by the pilot feature.

2. The vehicle of claim 1, wherein the pilot feature is positioned between the gear and the first bearing along the axis of rotation.

3. The vehicle of claim 1, wherein the motor comprises an electric motor including a rotor and a stator.

4. The vehicle of claim 3, wherein the pilot feature is configured to maintain a gap between the rotor and the stator.

5. The vehicle of claim 1, wherein a radial fit defined between the pilot feature and the shaft is about 0.1 millimeters to about 15 millimeters.

6. The vehicle of claim 1, wherein a length of the pilot feature is about 2 millimeters to about 60 millimeters.

7. The vehicle of claim 1, further comprising:
a gearbox cover removably couplable to the motor housing, the gearbox cover including the second bearing.

8. The vehicle of claim 7, further comprising:
one or more gears configured to mesh with the gear of the shaft, the one or more gears disposed within an interior of the gearbox cover when the gearbox cover is coupled to the motor housing.

9. The vehicle of claim 1, wherein the pilot feature is formed from a first material and the motor housing is formed from a second material that is different from the first material.

10. A drive unit comprising:
a shaft having a gear;
a motor configured to drive rotation of the shaft about an axis of rotation;
a first bearing configured to support the shaft;
a second bearing removably couplable to the shaft to support the shaft, wherein the gear is positioned between the first bearing and the second bearing along the axis of rotation when the second bearing is coupled to the shaft;
a motor housing; and
a pilot feature coupled to the motor housing,
wherein when the second bearing is decoupled from the shaft, the shaft is supported by the pilot feature, and
wherein when the second bearing is coupled to the shaft, the shaft is not supported by the pilot feature.

11. The drive unit of claim 10, wherein the pilot feature is positioned between the gear and the first bearing along the axis of rotation.

12. The drive unit of claim 10, wherein the motor comprises an electric motor including a rotor and a stator.

13. The drive unit of claim 12, wherein the pilot feature is configured to maintain a gap between the rotor and the stator.

14. The drive unit of claim 10, wherein a radial fit defined between the pilot feature and the shaft is about 0.1 millimeters to about 15 millimeters.

15. The drive unit of claim 10, wherein a length of the pilot feature is about 2 millimeters to about 60 millimeters.

16. The drive unit of claim 10, further comprising:
a gearbox cover removably couplable to the motor housing, the gearbox cover including the second bearing.

17. The drive unit of claim 16, further comprising:
one or more gears configured to mesh with the gear of the shaft, the one or more gears disposed within an interior of the gearbox cover when the gearbox cover is coupled to the motor housing.

18. The drive unit of claim 10, wherein the pilot feature is integrally formed with the motor housing.

19. A method for assembling a drive unit, comprising:
engaging a shaft of the drive unit with a pilot feature of a motor housing of the drive unit, the pilot feature supporting the shaft while the shaft is supported by a first bearing of a straddle two-bearing arrangement; and
coupling a gearbox cover to the motor housing to cause a second bearing of the straddle two-bearing arrangement to support the shaft, causing the pilot feature to disengage the shaft.

20. The method of claim 19, further comprising:
prior to the coupling, performing a test on a component of the drive unit, wherein the performing comprises:
engaging the shaft with a test machine, causing the pilot feature to disengage the shaft;
performing the test on the component of the drive unit while the test machine engages the shaft; and
disengaging the shaft with the test machine, causing the pilot feature to reengage the shaft.
